(19) United States
(12) Patent Application Publication
(10) Pub. No.: US 2008/0103772 A1
(43) Pub. Date: May 1, 2008

(54) Character Prediction System

(76) Inventor: Duncan Bates, Seattle, WA (US)

Correspondence Address: GREENBERG & LIEBERMAN, LLC, 2141 WISCONSIN AVE, N.W., SUITE C-2, WASHINGTON, DC, 20007, US

(21) Appl. No.: 11/933,110

(22) Filed: Oct. 31, 2007

Related U.S. Application Data
(60) Provisional application No. 60/855,589, filed on Oct. 31, 2006.

(51) Int. Cl. G10L 15/04

(52) U.S. Cl. 704/251; 704/E21.019

(57) ABSTRACT

When characters are provided, probabilities for each character are multiplied by the most heavily weighted word that could possibly be derived from the characters provided. The products are compared, and the greatest product is predicted to show the path to the word that the user presumably is entering. Second, third, etc. predictions are made such that the assumption of the first character and other characters can change once the first word prediction has been culled from the remaining possibilities.

### CONTINUITY DATA

This is a non-provisional application of U.S. provisional patent application No. 60/855,589 filed on Oct. 31, 2006, and priority is claimed thereto.

### FIELD OF THE INVENTION

The present invention is concerned with character recognition, and more particularly, the present invention attempts to predict the letter or number or other character that has been entered by a user. Most commonly, when a user enters a character, not by typing, but rather by his voice or by actual hand writing, identification of letters and words becomes problematic. The present invention is concerned with—as correctly as possible—identifying characters so that proper recognition is achieved. The present invention is especially directed at prediction and recognition of words.

### BACKGROUND OF THE INVENTION

It has been said that technology drives society forward. While this is true, as automobiles have allowed people to travel great distances, and planes have allowed people to traverse the Atlantic in a matter of hours, technology does not always move seamlessly. At times, one might wonder what roadblocks occur as technology progresses and man moves forward.

For example, cell phones have enabled people to communicate from nearly anywhere that people might be. Technology has even advanced to the point where cell phones are no longer truly a phone, but rather are better termed a hybrid device that combines cell phone technology with a variety of other common tools and applications, such as e-mail, instant messaging, picture taking, and actual note taking by hand. Some cell phones are even equipped to recognize the user's voice. So as technology has allowed the person to communicate from virtually anywhere with their cell phone, technology has also created problems. Typically, if a user jot down notes on a cell phone with a stylus, the cell phone needs to be capable of accurately recognizing which letters and words are actually been written by a stylus on the user's cell phone screen. Similarly, if a user says, “Dial 555-555-1212,” the cell phone needs to be able to recognize clearly that the user is saying the word “call” and that the user is actually going to call the numbers that the user just enunciated.

Herein is the problem that has been created with technology. In short, nobody wants to use a cell phone that has the capability to voice dial or to take voice notes—or to even use a cell phone that is capable of recognizing the user's handwriting—when a cell phone cannot do so accurately and reliably.

Thus, there is a need for a solution to a problem of handwriting and voice recognition that exists in today's technology driven age. Some solutions for recognizing a user's voice or a user's handwriting have involved guessing which character or which sounds the user or has just written or spoken. For example, if a user writes a capital “C”, then conventionally, there are programs that take a capital letter “C” that has been drawn by the user and perform a comparison between the entry and that which is in a database. The comparison typically would take the capital “C” entered by the user and compare it to a capital “C”, a capital “A”, and maybe a capital “D” to determine which letter the user has actually written.

Similarly if a user enunciates the word “facts” for word recognition, then there are conventional programs available that will compare the sound of the word “facts” to words in a database. The conventional programs will assume that the user has enunciated a word that most closely sounds like a word in the database.

Unfortunately, there are drawbacks to conventional methods of character recognition—whether they are recognizing written characters were spoken characters. One problem the conventional character identification systems have is that they assume that the first letter of a word is whichever letter has been determined by the program throughout the rest of the word identification process. In other words, if a conventional process determines that somebody has written or spoken a capital “D”, then conventional processes continue to try to identify the word that has been written or has been spoken by matching letters to the letters that have been written or have been spoken that would form the rest of the word beginning with a “D.”

The obvious drawback to conventional systems, like those described above, is that if the conventional system incorrectly identifies the first letter of a spoken or written word, then the conventional process and never actually recognizes the proper word that is actually being written or spoken. For example if a user writes or enunciates the word “tea,” and a conventional process recognizes that the “T” letter is actually the letter “M” then it will be impossible for the conventional process to ever guess or project the proper word that has been written or enunciated. The conventional process is flawed because the first letter has already been predetermined incorrectly. There is no way that the conventional process can possibly determine that the correct word is “tea” because the conventional process has incorrectly recognized the letter as an “M” and not a “T.” Thus, there is a need for a system that can correctly identify and predict words that are written and are spoken that does not add a constant assumption about the first letter of a word.

Furthermore, there are some conventional processes that attempt to recognize a word that has been written or spoken based on user input. In other words, three or four or five words are provided by the conventional process after a user has written or spoken a word, and it is up to the user to guess which word might be the actual word that has been written or has been spoken. In a sense, one could say that the conventional processes are heavily reliant upon the user to identify a word that has only been generally predicted by the conventional process. While user input is a helpful feature for a word prediction and identification process, there is a need for a process that can identify words based on criteria separate from direct user feedback. User feedback is not always available or desirable. Moreover, restated, there is a need for a process that can identify words that have been spoken or written by a user. The need is particularly for a process that has a method of allowing the process to change assumptions about which word a user might be speaking or writing. Furthermore, there is a need for a process that can identify words that have been spoken or written so that data is recognized without requiring a user to select one of several words that confirms the user's input.

Without question, the inability of current processes to accurately recognize words that have been written or spoken clearly hampers the advancement of technology. If somebody has a voice dial feature on a cell phone, but the voice dial feature is unable to correctly and reliably understand utterances, then the voice dial feature is essentially and operationally meaningless. In other words, the user might not ever employ the voice dial feature or might not desire the voice dial feature in the future. Similarly, if a user has a cell phone that allows the user to write with a stylus to take notes or to write a document, if the cell phone is incapable of correctly identifying the words and letters that are written in the user's own handwriting, then the feature is essentially meaningless. In fact, the feature might not as well be on the phone whatsoever. Thus, there is a pressing need for a better process of identifying characters such that the proper input desired by a user can be determined.

### SUMMARY OF THE INVENTION

The present invention is a system by which characters are recognized and formed into words, for example. According to the present invention, when a user writes on a cell phone with a stylus, and a user writes a capital “C,” then that letter is assumed to be one of several letters based on a probability for each letter that is provided to the present invention using a computer or similar processing device.

The present invention then makes weighted guesses as to which word the user is writing as the user continues to enter letters. The prediction of a word is essentially determined by the probability that a character entered is a particular letter, in combination with the weights that are given to the present invention for different words beginning with the most probable letter. According to the present invention, after a first letter has been entered and a first word is predicted, then a second letter is examined. Upon a second letter being entered by the user, the present invention then essentially begins its assumptions anew. That is, the present invention evaluates the two letters based on next letter probability. The probability that the first two letters might be a combination controls once a second letter has been entered.

Additionally, the two letter probability is also combined with weighting of words that is provided to the present invention so that the present invention is able to more accurately predict the word that the user is entering. In short, it would be correct to say that the present invention predicts the word that the user is writing, or speaking should input be via a voice recognition program, upon each letter entry that is recognized by the present invention.

For example, if the user speaks a letter “C,” then the present invention might assume that the user has said the letter “C” based on probability givens that are provided to the present invention. Next, the present invention looks to see which of many words is the most heavily weighted that could possibly, from that first letter that has been determined as most probable, be the word that will be or is being entered.

In other words, the present invention assumes the word that the user is about to or has just spoken is a word based upon a particular process. The present invention finds the product of the probability of that most common first letter and the most heavily weighted word that could begin with that first letter. Upon entry or processing of a second letter, the present invention then looks to the probability of a first letter in combination with the probability of a second letter of a subset that that letter could be. The product of the two probabilities is then factored together with the most heavily weighted word that could possibly be derived from the highest product of the probabilities. It should be recognized that by constantly reevaluating probabilities of one letter, a combination of two letters, or even a combination of three or more letters, the present invention is able to predict words without assuming that the first letter is constant.

Another important feature of the present invention is that it does not assume that a possible, first, second, or third, etc. letter is always constant. According to the present invention, it is the combination of potential first, second, third, etc. letters that drives the possible answer to which word the user is entering. Thus, the present invention might initially assume that the user has entered a letter “C” at first; but upon the entry or processing of a second letter, the present invention might then change the assumption of the letter “C” to a letter “E.” The changing of assumptions of letters continues until a word is properly identified. The non-constant assumption of letters based upon letter probabilities and word weights from those letters makes the present invention well suited for character recognition, especially when multiple characters are involved to form words.

### BRIEF DESCRIPTION OF THE DRAWINGS

FIG. 1 shows the decision tree of the present invention.

FIG. 2 shows the word weights on the decision tree of the present invention.

FIG. 3 shows the product calculations when one character is provided to the present invention.

FIG. 4 shows the culling of the word “abba” on the decision tree of the present invention.

FIG. 5 shows the product calculations when two characters are provided to the present invention.

### DETAILED DESCRIPTION

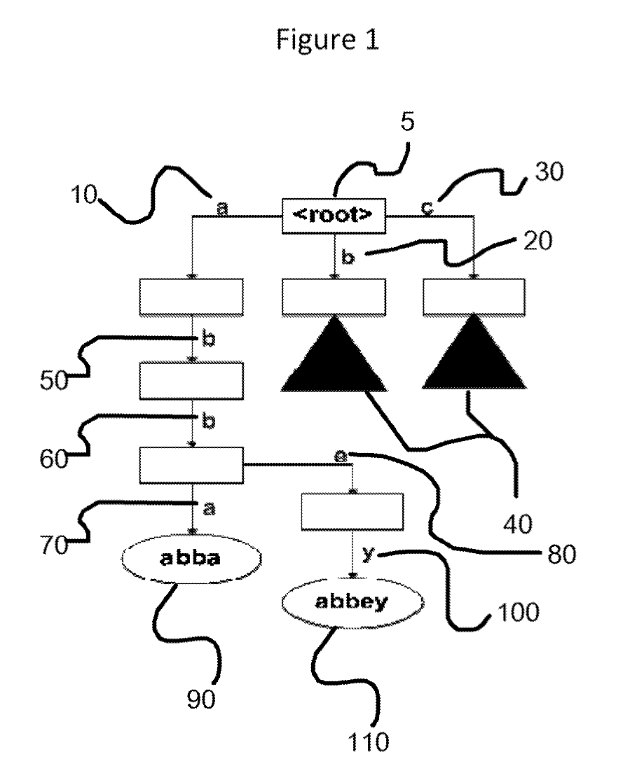

As shown in FIG. 1, the present invention is a decision-tree type process to ascertain a word being entered by a user. According to FIG. 1, a first letter is entered at root 5 that could possibly be a letter “a” 10 or a letter “b” 20 or a letter “c” 30. For purposes of explanation in FIG. 1, black triangles 40 represent that there are no letters or words that are shown should the letter entered at root 5 be letter “b” 20 or letter “c” 30. Assuming that letter “a” 10 is the letter entered at root 5, then letter “b” 50 is predicted to be the second letter of the word, and letter “b” 60 is predicted to be the third letter of the word. The fourth letter of the unknown word might be either letter “a” 70 or letter “e” 80.

If the fourth letter of the unknown word is predicted to be letter “a” 70, then the present invention predicts, according to FIG. 1, that the word entered or being entered is the word “abba” 90. On the other hand, if the fourth letter of the unknown word is predicted to be the letter “e” 80, then the present invention predicts, according to FIG. 1, that the fifth letter is “y” 100; resulting in the word entered or being entered as being determined to be the word “abbey” 110.

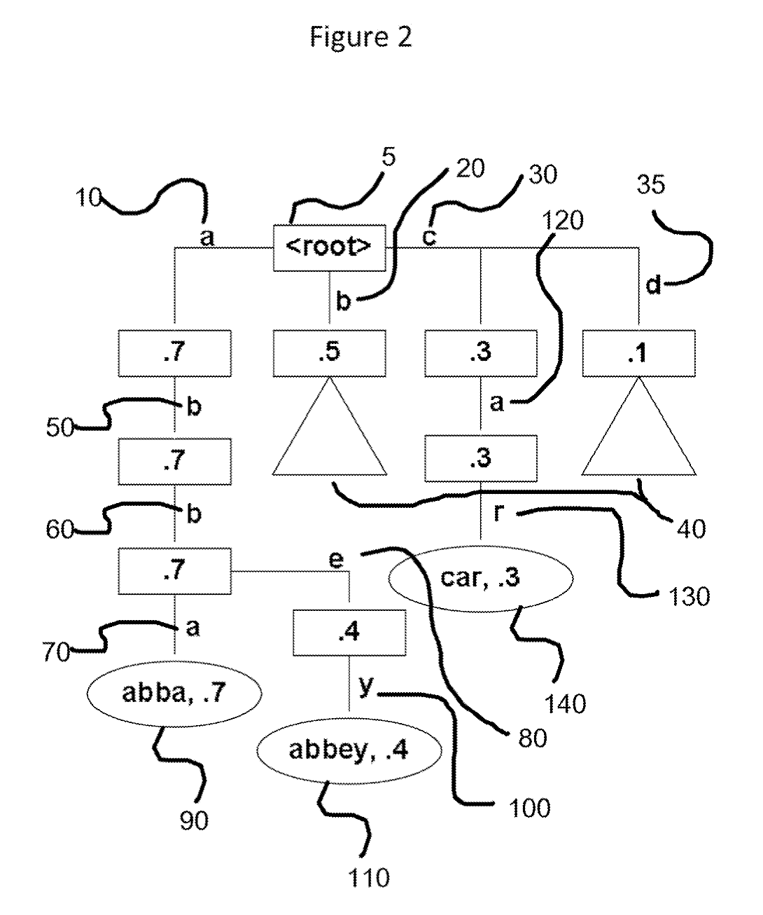

Turning to FIG. 2, the important point to realize is that the present invention has given probabilities that are associated with certain letters. The given probabilities are not generated by the present invention, but rather, are provided to it from another program or other method of inputting data. The box following “a” 10 shows that there is a 0.7 weight that “b” 50 is the next letter after “a” 10. The box under “b” 20 shows that there is a 0.5 weight that the black triangle 40 is the next letter after “b” 20. The box under “c” 30 shows that there is a 0.3 weight that “a” 120 is the next letter after “c” 30. The box under “d” 35 shows that there is a 0.1 weight that the black triangle 40 is the next letter after “d” 35.

Similarly, the box under “b” 50 shows that there is a 0.7 weight that “b” 60 is the next letter after “b” 50; the box under “b” 60 shows that there is a 0.7 weight that “a” 70 or “e” 80 is the next letter after “b” 60; the circle under “a” 70 shows that there is a 0.7 weight that the word “abba” 90 is the word that is being identified.

Also possible, but less heavily weighted, is that if “e” 80 is the letter following “b” 60, then there is a 0.4 weight that “y” 100 is the next letter after “e” 80. The circle under “y” 100 shows that there is a 0.4 weight that the word “abbey” 110 is the word that is being identified.

Following the explanation of FIG. 2 already provided above, it should be evident how the word “car” 140 could possibly be the word that is being identified. As aforementioned, the box under “c” 30 shows that there is a 0.3 weight that “a” 120 is the next letter after “c” 30. Similarly, the box under “a” 120 shows that there is a 0.3 weight that “r” 130 is the next letter after “a” 120. The circle under “r” 130 shows that there is a 0.3 weight that the word “car” 140 is the word that is being identified.

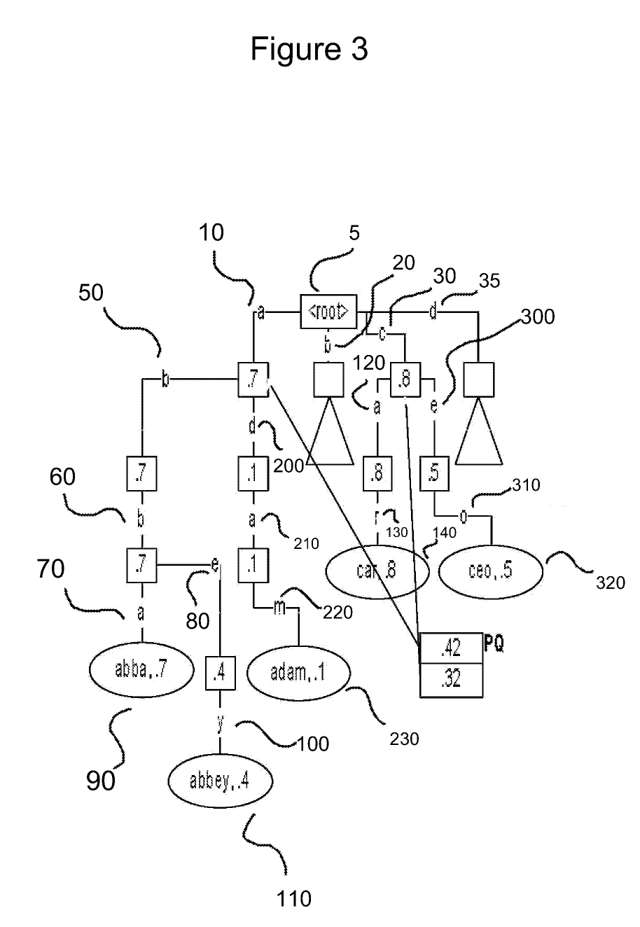

FIG. 3 shows that the weights that the decision tree might take are multiplied by the probabilities of possible first letters “a” 10, “b” 20, “c” 30, and “d” 35 to determine a probable path to correctly predicting the word that is being identified. Also, FIG. 3 shows that there is another branch of the decision tree that has “d” 200, “a” 210, and “m” 220 resulting in the word “adam” 230. According to the present invention, if the decision tree is constructed as per FIG. 3, then the probability of the first letter needs to be multiplied by the weights. For example, if “a” 10 has a given probability of 0.6, then 0.6 would be multiplied by the weight 0.7 below “a” 10, generating a product of 0.42. This product is compared with the products of performing the same calculation for the other branches of the decision tree of the present invention. Thus, if “c” 30 has a given probability of 0.4, then 0.4 would be multiplied by the weight of 0.8 below “c” 30, generating a product of 0.32. Important is that only because the product 0.42 is greater than the product 0.32, the present invention would assume that the word to be identified must begin with “a” 10. Since the more heavily weighted path is to the word “abba” 90, the present invention's first prediction would be that the word to be identified is “abba” 90.

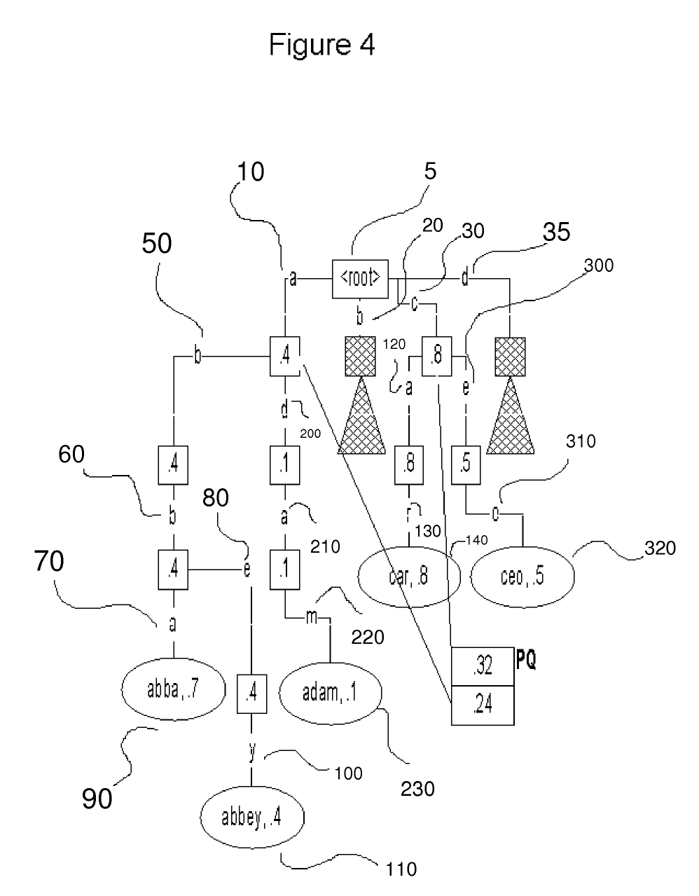

As shown in FIG. 4, once the word “abba” 90 is determined to be the first choice for the unknown, then the weight of the box under “a” 10 is replaced. Formerly, as shown in FIG. 3, the weight of the box under “a” 10 was 0.7—this was controlled by the highest weight of the word that could ultimately come from that path on the decision tree—corresponding to the weight of the word “abba” 90. Now, though, as shown in FIG. 4, because the word “abba” 90 has already been chosen by the present invention as the first choice for the unknown, the word “abbey” 110 with a weight of 0.4 controls the weight of the box under “a” 10. Thus, the weight of the box under “a” 10 is shown in FIG. 4 as being 0.4—a significant weight because it will effect the present invention's second prediction of the word to be identified.

Per FIG. 4, the weights that the decision tree might take are multiplied by the given probabilities of first letters “a” 10, “b” 20, “c” 30, and “d” 35 to determine a probable path to correctly predicting the word that is being identified. Now, because the box under “a” 10 is a weight of 0.4, the probability of “a” 10 is multiplied by the weight 0.4 to generate a product of 0.24 since the given probability of “a” 10 is 0.6. Similarly, the because the box under “c” 30 is a weight of 0.8, the probability of “c” 30 is multiplied by the weight of 0.8 to generate a product of 0.32 since the given probability of “c” 30 is 0.4.

FIG. 4 illustrates an important point: that although the present invention predicted initially that the first letter of the unknown was “a” 10; now, with the word “abba” 90 having been essentially culled from the decision tree because “abba” 90 was the first supposition for the word to be identified, the change in weights aforementioned caused the products calculated for the “a” 10 and “c” 30 to favor “c” 30 as the first letter for the word that is being identified. In other words, because “abba” 90 has been removed from the decision tree of the present invention, weights changed based on the remaining possible words that could be the unknown word. And when weights changed, the product of 0.32 for “c” 30 with a given probability of 0.4 and a weight of 0.8, is greater than the product of 0.24 for “a” 10 with a given probability of 0.6 and a weight of 0.4.

The same procedure is followed as already described, according to the present invention, to determine if the second choice for the word to be identified is either “car” 140 or “ceo” 320. In the case shown in FIG. 4, “car” 140 has a greater weight than “ceo” 320—0.8 versus 0.5, respectively. Thus, the present invention would have “car” 140 as the second choice for the word to be identified.

If not already noted, whether first letters “a” 10, “b” 20, “c” 30, and “d” 35 are the first letters available is a given provided to the present invention. The present invention does not compare sounds enunciated with known enunciations so to speak, but rather, the present invention operates to take given choices that have probabilities and weights to determine first and second choices for an unknown word.

As shown in FIG. 4, the present invention is able to have a first choice being a first letter “a” 10, but have a second choice have a first letter “c” 30. This is important because the present invention is able to change the initial assumption about the first letter of the word to be identified based upon given probabilities and weights, as already described. The products of probabilities and weights determine the first and following letters of a word to be identified. There is not, contrary to conventional processes, an identification of a first letter and possible words that could emanate from that first letter only; with the present invention, if the probability and weight products dictate that a word with a different beginning first letter(s) is a second possibility for the word to be identified, then a word with a different beginning first letter(s) can be that second possibility for the word to be identified.

Continuing with the concept of the present invention, once “car” 140 is chosen as the second choice for the unknown word, then “car” 140 is culled from the decision tree of the present invention, and the weight under “c” 30 will change to the next highest weighted word that could ultimately come from “c” 30 according to the decision tree—in this case 0.5 because of the word “ceo” 320.

Then the determination of products occurs again for a third round according to the present invention. The probability of “a” 10, which is 0.6, is multiplied by the weight of 0.4 to generate a product of 0.24; and the probability of “c” 30, which is 0.4 is multiplied by the weight of 0.5 to generate a product of 0.20. Because the product 0.24 is greater than the product of 0.20, the present invention would move down the decision tree to determine the third possibility for the word to be identified starting with the letter “a” 10. The same process as already described is followed by the present invention to determine possibilities for the unknown word.

It should be recognized that the possible first letters could easily be more than that which has been illustrated, and that the examples provided are simplistic in terms of choices of first letters and trees of words for explanation purposes. For example, there could be thousands of words and thousands of trees, all operating according to the present invention as already described.

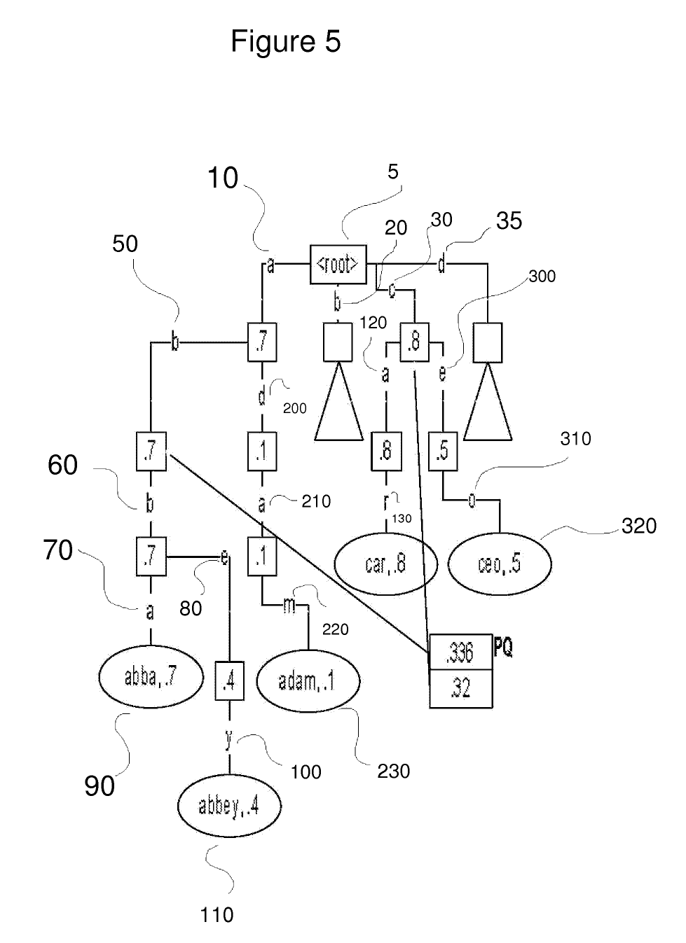

FIG. 5 shows the present invention as already described, but with a twist. Instead of the user of the present invention entering but one letter, or having merely one letter analyzed by the present invention to arrive at a possibility for the unknown word, the present invention takes multiple character input. Just as previously described, a first letter's probability is multiplied by the weight of a particular branch of the decision tree. However, because now there are two letters entered into the present invention, a probability for the first letter and a probability for the second letter are multiplied by the weight of a particular branch of the decision tree. If there are three letters entered into the present invention, then the probabilities of each of those letters are multiplied together and by the weight of a particular branch of the decision tree for the next unentered letter. Similarly, the same pattern occurs dependent only on the number of characters entered. So if seven characters were entered, then the present invention would take a probability for each character place. The seven probabilities would be then multiplied by the weight of each branch of the tree for an eighth character.

FIG. 5 illustrates the concept of multiple entered letters just described. There are two characters or letters entered in the example shown in FIG. 5. In other words, the user has provided to the present invention either directly, or via other conventional processes such as character recognition software, two characters, then FIG. 5 shows how the present invention proceeds. Letter “a” 10 has a probability of 0.6 that is given to the present invention; letter “b” 50 has a probability of 0.8 that is given to the present invention; and the weight under letter “b” 50 (that has been given to the present invention) is 0.7—0.7 being the weight from the most heavily weighted word down the decision tree at that point. Thus, the product of 0.6, 0.8, and 0.7 is 0.336.

The 0.336 product is compared with similarly derived products. In the example shown in FIG. 5, because there are not any represented words in the decision tree under letter “b” 20 and letter “d” 35, the only decision tree area to compare with is that derived from letter “c” 30. Letter “c” has a probability of 0.4, letter “e” 300 has a probability of 0.2, and 0.5 is the weight from the most heavily weighted word down the decision tree from “e” 300. The product of 0.4, 0.2, and 0.5 is 0.04; and because 0.04 is less than 0.336 obtained above, the present invention would identify “abba” 90 as the first possibility for the word to be identified.

It is important to note that the full calculation that obtained 0.04 was not necessary. Even though two characters were input into the present invention, if the probability of just the first character—“c” 30—and the weight of the most heavily weighted word down the decision tree that could possibly come from “c” 30 are multiplied together, a comparison is made by the present invention to 0.336 product already obtained. In the case of the example shown in FIG. 5, the product of the probability of “c” 30 and the weight of the most heavily weight word down the decision tree that could possibly come from “c” 30 is 0.32. Because 0.336 is greater than 0.32, the present invention would not need to calculate (and would not calculate for sake of time and processing power with a computer) the product 0.04. So in short, even though two letters have been input into the present invention, the present invention would attempt to calculate the product of the probability of the first letter and the weight of the most heavily weighted word down the decision tree that could possibly come from that first letter. The probabilities of words is always a decimal less than or equal to 1; so it follows that if a first letter and most heavily weighted word product is already lower than another first letter and most heavily weighted word product, then there is no point in using a second, third, or fourth letter's probability. This follows because multiplying a number by a number less than 1 is always going to lower the number even further, and multiplying a number by 1 is always going to keep the number the same.

The example, as shown in FIG. 5, can continue as did the example shown in FIG. 4, such that once a first prediction of the unknown word is made by the present invention, that word is culled from the decision tree, and the next most heavily weighted word down that branch of the decision tree controls the weight factor in the product calculation. For example, in FIG. 5, once “abba” 90 is predicted by the present invention as the unknown word, then “abba” 90 is culled from the decision tree and “abbey” 110 controls the weight factor used to obtain a product—so 0.4 is used to obtain a product rather than 0.7. If the use of 0.4 causes the product to be lower than the product of another branch of the decision tree of the present invention, then the second prediction for the unknown word would not be “abbey” 100, but whichever word is the most heavily weighted word down the branch of the decision tree that has the highest product.

It should be understood that the operations described above can continue as more and more characters are entered into the present invention. Conceivably, the user would have the option to choose the first, second, etc. prediction provided by the present invention.

Further, although the present invention has been explained by way of word recognition, the present invention is applicable to any character string identification—whether characters are letter and the strings are words does not matter. For purposes of explanation above, letters and characters were used but should not be viewed as limiting of the present invention.

It should be understood the present invention is not merely the embodiment(s) described above, but can be any and all embodiments within the scope of the following claims.

I claim:

1. A system for character string identification, comprising:
inputting an unknown character;
inputting a given probability for each possible character match;
inputting a given weight for each character string that could result from each possible character match;
multiplying a given probability for each possible character match by a given weight for each character string that could result from each possible character match to obtain a product; and
selecting a character string associated with the highest product as the character string that is being identified.

2. The system of claim 1, wherein the unknown character is a letter.

3. The system of claim 1, wherein each possible character match is a letter.

4. The system of claim 1, wherein each possible character string is a word.

5. The system of claim 1, wherein the given probability for each possible character match is less than or equal to 1.

6. The system of claim 1, wherein the given weight for each character string that could result from each possible character match is less than or equal to 1.

7. The system of claim 2, wherein each possible character match is a letter.

8. The system of claim 2, wherein each possible character string is a word.

9. The system of claim 2, wherein the given probability for each possible character match is less than or equal to 1.

10. The system of claim 2, wherein the given weight for each character string that could result from each possible character match is less than or equal to 1.

11. The system of claim 3, wherein each possible character string is a word.

12. The system of claim 3, wherein the given probability for each possible character match is less than or equal to 1.

13. The system of claim 3, wherein the given weight for each character string that could result from each possible character match is less than or equal to 1.

14. The system of claim 4, wherein the given probability for each possible character match is less than or equal to 1.

15. The system of claim 4, wherein the given weight for each character string that could result from each possible character match is less than or equal to 1.

16. The system of claim 5, wherein the given weight for each character string that could result from each possible character match is less than or equal to 1.

17. The system of claim 1, wherein the unknown character is a letter; wherein each possible character match is a letter; wherein each possible character string is a word; wherein the given probability for each possible character match is less than or equal to 1; and wherein the given weight for each character string that could result from each possible character match is less than or equal to 1.

18. The system of claim 1, further comprising culling the character string associated with the highest product, and then selecting a character string associated with the next highest product as the character string that is being identified.

19. The system of claim 18, wherein the unknown character is a letter; wherein each possible character match is a letter; wherein each possible character string is a word; wherein the given probability for each possible character match is less than or equal to 1; and wherein the given weight for each character string that could result from each possible character match is less than or equal to 1.

20. A system for character string identification, comprising:
predicting an unknown character string from at least one unknown character by multiplying probabilities assigned to characters by weights assigned to character strings.
